(19) United States
(12) Patent Application Publication
(10) Pub. No.: US 2002/0121041 A1
(43) Pub. Date: Sep. 5, 2002

(54) Fishing gaff and net with a line guide

(76) Inventor: Jane Haggerty, North Haven, CT (US)

Correspondence Address: Jane Haggerty, 18 Juniper Drive, North Haven, CT, 06473, US

(21) Appl. No.: 09/798,380

(22) Filed: Mar. 5, 2001

(51) Int. Cl. A01K 97/14

(52) U.S. Cl. 43/5

(57) ABSTRACT

The invention adds function to standard fishing gaffs of fishing nets to guide the fishing line clear of obstacles using the same gaff or net used to land the fish.

### BACKGROUND OF THE INVENTION

This invention pertains to fishing. When landing fish, particularly ones larger for the tackle being used, it is often difficult from keeping the fishing line clear of obstacles or abrading on obstacles that cause the fishing line to break. Either of these two condition usually leads to loss of the fish.

This invention provides the angler or an assistant the ability to guide the line around such obstacles and avoid loss of the fish.

### BRIEF SUMMARY OF THE INVENTION

The invention is an improvement to the standard gaffs or nets used by fishermen. The line guide is used to keep the fishing line clear of obstacles while the fish is being fought. This will allow the line to stay clear of boat running gear (outboard motors, inboard/outboard drives, or inboard rudders or propellers) or other obstacles preventing the fish to reach a distance where the angler can gaff or net the fish.

### BRIEF DESCRIPTION OF THE SEVERAL VIEWS OF THE DRAWINGS

FIG. 1 shows the invention used on a gaff, both one and two-way guides.

FIG. 2 shows the invention used on a net, both one and two-way guides.

### DETAILED DESCRIPTION OF THE INVENTION

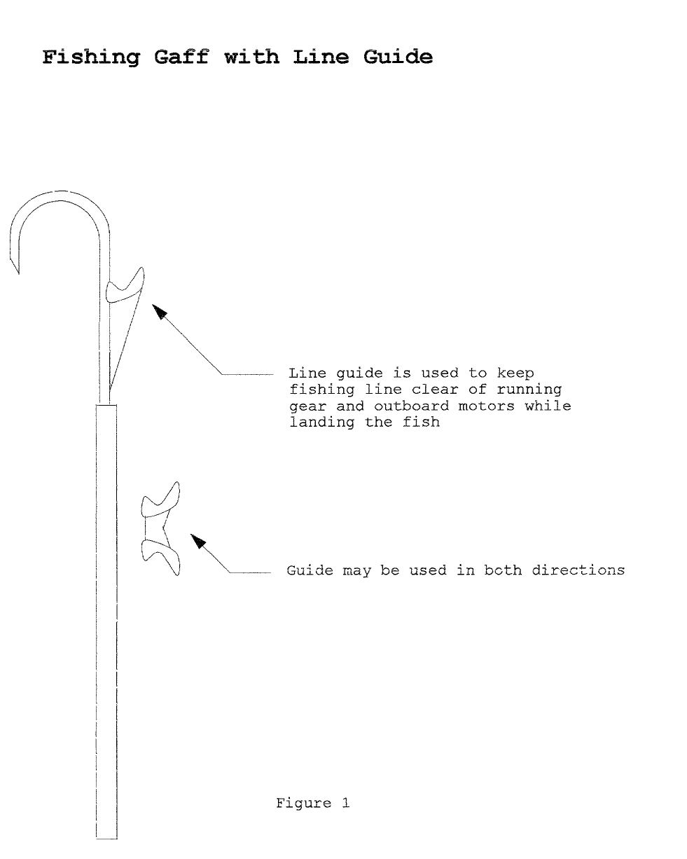

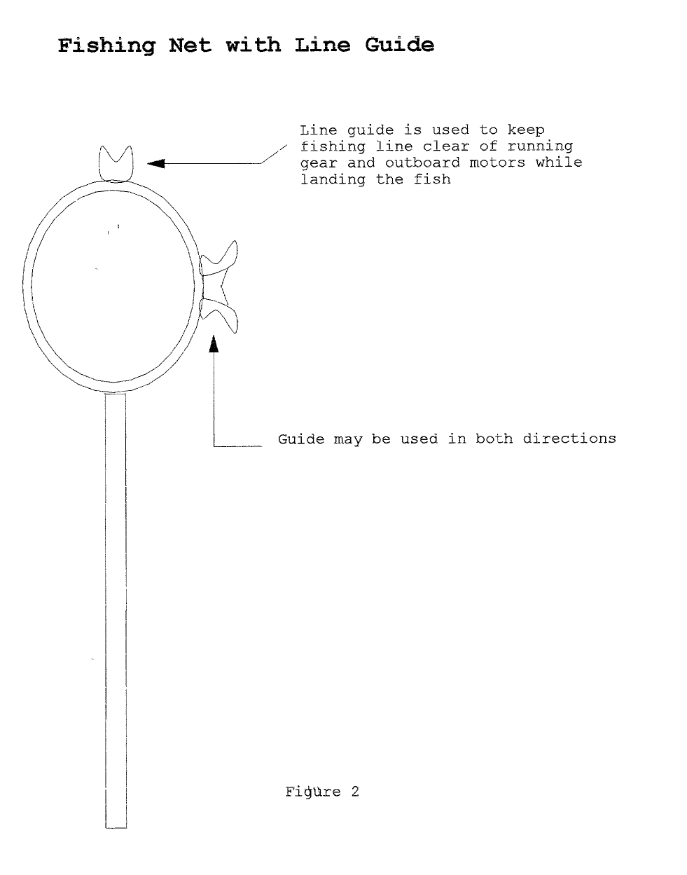

The invention enables the angler or an assistant to hook onto the fishing line using a smooth rounded catch and move the line clear of obstacles, then release the line to capture the fish, reference FIGS. 1 and 2. This smooth rounded catch is orientated to the gaff or net to allow easy line engagement or line release. Size of the guide and orientation on the gaff or net may vary depending on the type of fishing the gaff or net is designed for.

The line guide may be fabricated integral to the gaff hook or net frame or add to standard gaff or nets as an attachable feature. The smooth rounded catch should be designed to allow movement of the line to the greatest angle without making engagement and release difficult.

I claim:

1. The invention allows a fishing angler to guide the fishing line and fish clear of obstacles in order to prevent the line from fouling or breaking due to chafing while landing fish.

2. The invention allows a fishing angler's assistant to guide the angler's line and fish clear of obstacles in order to prevent the line from fouling or breaking due to chafing while landing fish.

3. The invention allows retrieval of lines to the angler when the two-way guide is used so the line can be managed by hand.
